(19) United States
(12) Patent Application Publication
(10) Pub. No.: US 2019/0234207 A1
(43) Pub. Date: Aug. 1, 2019

(54) OPTIMIZATION OF RATE-OF-PENETRATION

(71) Applicant: GE Inspection Technologies, LP, Lewistown, PA (US)

(72) Inventors: Arun Karthi Subramaniyan, Danville, CA (US); Haiming Zhao, San Ramon, CA (US); Imran Younus, Lewistown, PA (US); Shourya Otta, Lewistown, PA (US); Fabio Nonato de Paula, Lewistown, PA (US); Mahadevan Balasubramaniam, Niskayuna, NY (US)

(21) Appl. No.: 16/258,007

(22) Filed: Jan. 25, 2019

Related U.S. Application Data
(60) Provisional application No. 62/622,733, filed on Jan. 26, 2018.

(51) Int. Cl. E21B 49/00; E21B 45/00; E21B 47/12; G06N 7/00; G06N 3/08

(52) U.S. Cl. CPC E21B 49/003; E21B 45/00; G06N 3/088; G06N 7/005; G06N 3/086; E21B 47/12

(57) ABSTRACT

A method includes receiving sensor data characterizing one or more properties of a first formation undergoing drilling; determining, based on the received sensor data and a plurality of clustered historical data, an identity of the first formation; determining, based on one or more of the identity of the first formation and a target rate of penetration, a target operating parameter of a drill configured to penetrate the first formation, the target operating parameter configured to achieve the target rate of penetration of the drill through the first formation; and varying the operation of the drill based on the target operating parameter. Related apparatus, systems, articles, and techniques are also described.

### RELATED APPLICATION

This application claims priority under 35 U.S.C. § 119(e) to U.S. Provisional Patent Application No. 62/622,733 filed on Jan. 26, 2018, the entire contents of which are hereby expressly incorporated by reference herein.

### BACKGROUND

The speed at which a drill penetrates through the ground is referred to as Rate of Penetration (ROP). ROP can depend on operating parameters of the drill such as the downward force exerted on the drill bit (“weight on bit”) and angular rotational speed of the drill bit. ROP can also depend on the rock formation encountered during the drilling process. For example, for a given set of operational parameters, ROP can increase in fast drilling formations (e.g., sandstone) and can decrease in slow drilling formations (e.g., shale).

A desirable ROP for a rock formation can depend on, for example, density of the rock formation, porosity of the rock formation and the like. Therefore, when a drill enters a rock formation, its operating parameters (e.g., weight on bit, speed of rotation, and the like) may need to be changed to achieve the desirable ROP for the rock formation. Currently, the operating parameters of drilling (and the resulting ROP) can be determined by operators based on their experience.

### SUMMARY

In general, apparatus, systems, methods and article of manufacture for optimization of rate-of-penetration are provided.

In an aspect, a method includes receiving sensor data characterizing one or more properties of a first formation undergoing drilling; determining, based on the received sensor data and a plurality of clustered historical data, an identity of the first formation; determining, based on one or more of the identity of the first formation and a target rate of penetration, a target operating parameter of a drill configured to penetrate the first formation, the target operating parameter configured to achieve the target rate of penetration of the drill through the first formation; and varying the operation of the drill based on the target operating parameter.

One or more of the following features can be included in any feasible combination. For example, the method can include generating clustered historical data. The generating can include receiving historical sensor data indicative of detected properties of a plurality of formations including the first formation; encoding the historical sensor data into encoded data; clustering the encoded data into a plurality of clustered encoded data indicative of the plurality of formations; and clustering the historical sensor data into a plurality of clustered historical data based on the plurality of clustered encoded data. The plurality of clustered historical data can be indicative of the plurality of formations. Clustering the encoded data into the plurality of clustered encoded data can include applying an unsupervised clustering algorithm on the encoded data. The unsupervised clustering algorithm can be configured to identify a first formation property in the encoded data; and cluster the encoded data based on the first formation property. Determining the identity of the first formation can include identifying a first clustered historical data of the plurality of clustered historical data representative of the received sensor data; and setting the identity of the first formation to a formation associated with the first clustered historical data. The method can include generating a predictive model for the first formation based at least on the first clustered historical data. The predictive model can be configured to determine the target operating parameter based on the identity of the first formation and the target rate of penetration. Generating the predictive model can include determining one or more coefficients of a characteristic equation, the characteristic equation configured to receive a value representative of the first formation and the target rate of penetration as an input and generate the target operating parameter as an output. The predictive model can include one of a Bayesian hybrid model and a Gaussian process based model. The predictive model can be generated by a global evolutionary algorithm.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### BRIEF DESCRIPTION OF THE FIGURES

These and other features will be more readily understood from the following detailed description taken in conjunction with the accompanying drawings, in which:

FIG. 1 illustrates an exemplary method of determining target operating parameters of a drill;

FIG. 2 illustrates an exemplary encoding process;

FIG. 3 illustrates clusters of historical data segments;

FIG. 4 illustrates plots representing the detected gamma radiation, density and porosity of sensor data segments at various borehole depths;

FIG. 5A illustrates target rate of penetration values on a three dimensional plot of rate of penetration;

FIG. 5B illustrates is a two dimensional representation of the plot in FIG. 5A; and

FIG. 5C illustrates convergence of the values of rate of penetration in FIG. 5A for various iterations of an optimization algorithm.

### DETAILED DESCRIPTION

Operating parameters of a drill may need to be changed based on rock formations encountered while drilling. This can improve and/or maintain the performance of the drill as it bores through multiple rock formations. Currently, the drill operating parameters can be determined by an operator (or multiple operators) based on prior experience of the operator. But manually changing the operating parameters can be inefficient, and can result in undesirable performance of the drill. The current subject matter can provide for methods and systems that can be used to determine the desirable drill bit operating parameters for one or more rock formations. The method can be based on previously collected data (e.g., density, porosity, gamma, and the like) of the rock formations. The method can be used to determine the desirable drill operating parameters in real-time using data from sensors coupled to the drill bit. By improving the rate of penetration, the performance of the drill can be improved resulting in reduction of the operational costs, faster drilling times, reduction of wear and tear on the bit, and the like.

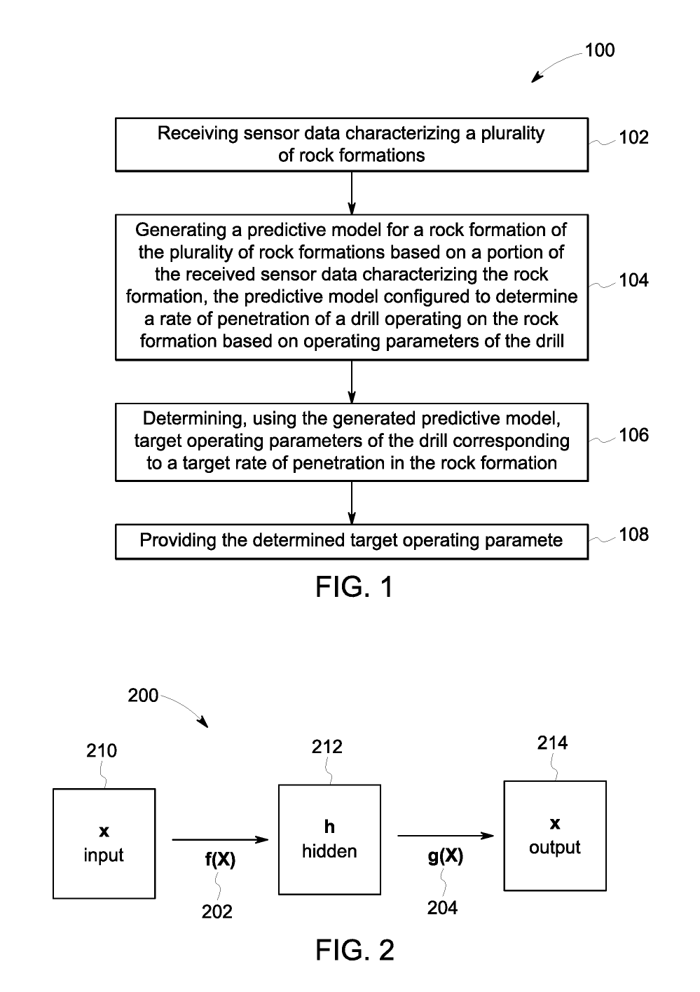

FIG. 1 illustrates an exemplary method of determining target operating parameters of a drill. At 102, sensor data characterizing one or more properties of a first rock formation (or a plurality of rock formations) is received (e.g., a rock formation undergoing drilling). The sensor data can include, for example, properties of rock formations (e.g., density, porosity, gamma radiation, and the like) that have been previously detected. The sensor data can be received in real-time from sensors coupled to a drill configured to penetrate the first rock formation. In some implementations, sensor data can be detected by sensors attached to a drill during previous drilling operations, and the sensor data can be saved in a database. The sensors can include, for example, gamma ray detectors, neutron detectors, resistivity sensors, and the like. The sensor data from a borehole (e.g., from a borehole at an oil rig) can be in the form of a well log. The received sensor data can be organized into sensor data segment. Each sensor data segment can include sensor data collected at a certain depth in the borehole.

Returning to FIG. 1, at 104, a predictive model for a first rock formation of the plurality of rock formations can be generated. An identity of the first rock formation can be determined from the sensor data received at step 102, clustered historical data, etc. The clustered historical data can be generated by encoding historical data (e.g., data associated with the first rock formation that was detected in the past) into encoded data, clustering the encoded data into clustered encoded data and clustering the historical data into clustered historical data based on the clustering of the encoded data.

In one implementation, historical data can be received (e.g., from a database, provided by a user, etc.). The historical data can be encoded into a compressed representation (e.g., latent data set) using a deep learning method. For example, a segment of the historical data can be encoded into an encoded data segment. The dimension of the historical data segment can be greater than the dimension of the encoded data segment. In one implementation, the deep learning method can be implemented using a deep convolutional auto-encoder (DCAE). These deep learning methods can report plurality of rock formations based on encoded data without having to identify type of rock such as limestone.

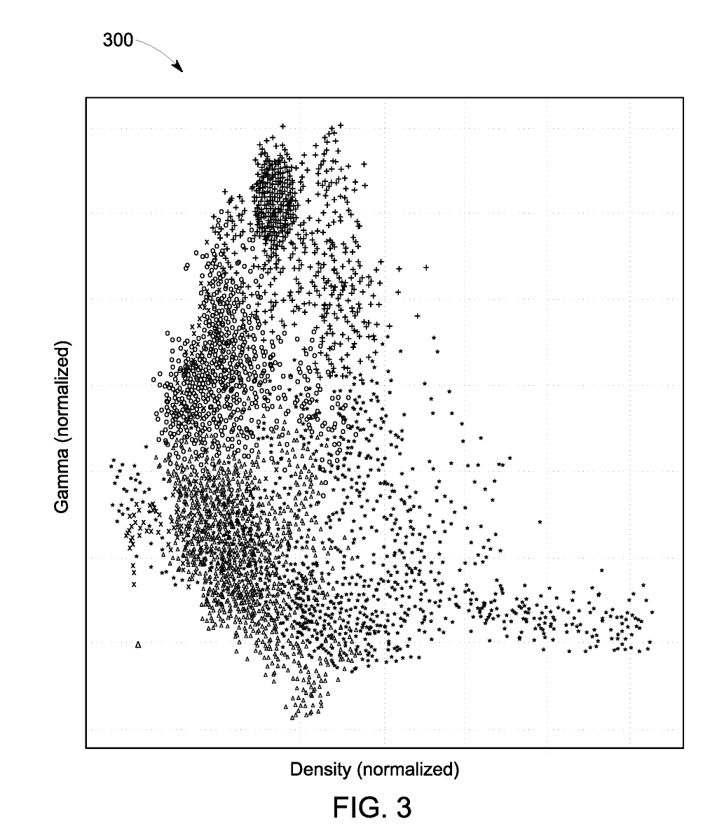

FIG. 2 illustrates an exemplary encoding model 200 by an encoding processor. The encoding model can include an encoding step 202 (by an encoder) and a decoding step 204 (by a decoder). The encoder can receive an input data 210 (e.g., encoded data segment) and can transform the input data 210 to a hidden code 212. The decoder can generate output data 214 from the hidden code 212. In one implementation, the encoding model can include a neural network that can be trained based on the training data (e.g., encoded data segment). Once the encoding model is trained, the output data 214 can converge to the input data. The encoding model can learn/identify the underlying manifold/a common characteristic of the encoded data segment.

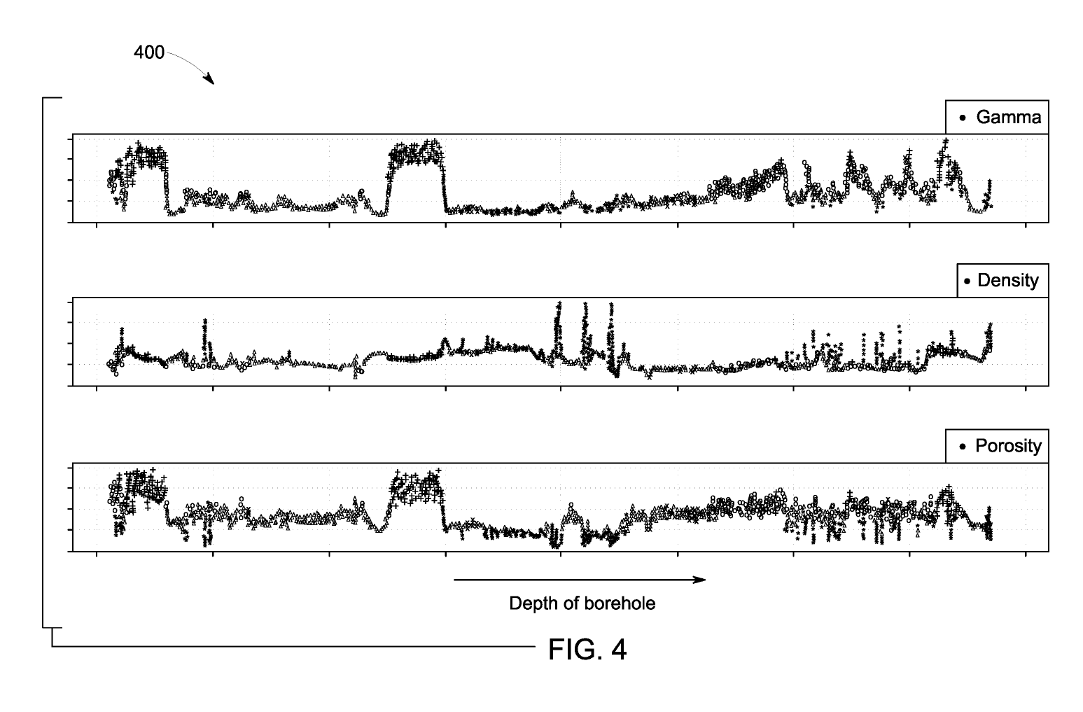

The encoded data segments can be grouped into one or more clusters. This can be done, for example, by using a statistical classification method. The statistical classification method can be an unsupervised clustering algorithm (e.g., parallel Louvain algorithm). Each cluster of encoded data segments can be representative of a rock formation. Based on the grouping of encoded data segments, the corresponding historical data segments can also be grouped into clusters. FIG. 3 is a plot illustrating clusters of historical data segments. As shown in FIG. 3, historical data segments have been divided into five distinct clusters (represented by different symbols) that can be representative of five distinct rock formations. The x-axis represents normalized density values and the y-axis represents normalized gamma radiation value in the historical data segments. The density values and the gamma radiation values of the historical data segments can be normalized by the depth of the borehole where these values have been detected.

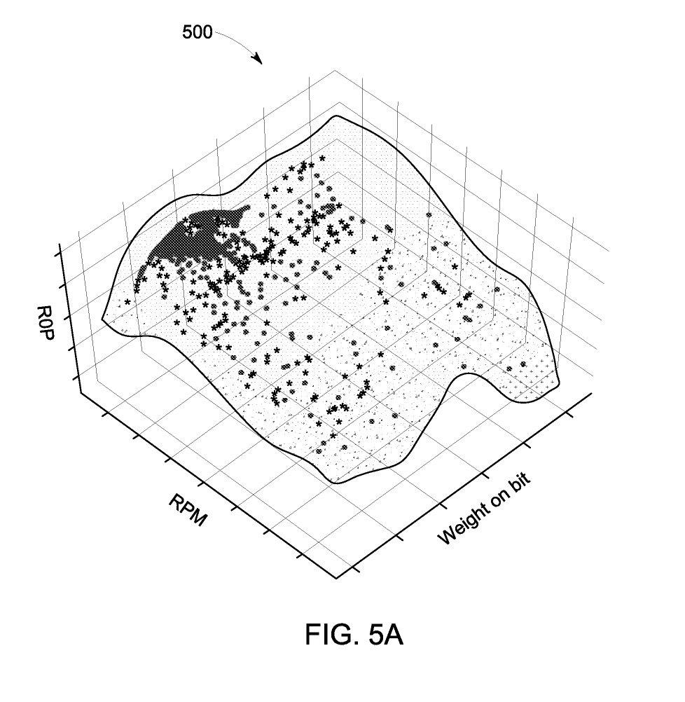

FIG. 4 illustrates plots representing the detected gamma radiation, density and porosity of sensor data segments at various borehole depths. The symbol used in the plot is representative of the rock formation whose gamma radiation, density and porosity is plotted. FIG. 4 illustrates that a given rock formation can occur at various depths.

Based on the historical data segments, the first rock formation associated with the sensor data received at step 102 can be identified. This can be done, for example, by comparing the received sensor data with the various historical data segments. If there is a match between the sensor data and a historical data segment (e.g., the sensor data and the historical data segment have a common identifier), the identity of the first rock formation can be set to that of the rock formation associated with the matched historical data segment.

After the rock formations have been identified, a predictive model (e.g., Bayesian Hybrid model) can be generated for the first rock formation based on the historical data (e.g., the matched historical data segment), sensor data received at step 102, predetermined properties of the drill used for penetrating the first rock formation (e.g., clustered rock formation). In some implementations, the predictive model can include determining one or more coefficients of a characteristic equation (e.g., a polynomial equation) of the first rock formation. The characteristic equation can be predetermined and can be based on, for example, rock formation properties, properties of the drill (e.g., weight on bit, speed of rotation of the bit, and the like), etc. The characteristic equation can be configured to receive a value representative of the first rock formation and the target rate of penetration as an input and generate a target operating parameter of the drill as an output (e.g., an operating parameter of the drill that can result in the target rate of penetration through the first rock formation). In some implementations, the predictive model can determine rate of penetration of a drill operating on the rock formation based on operating parameters of the drill (e.g., weight on bit, speed of rotation of the bit, and the like).

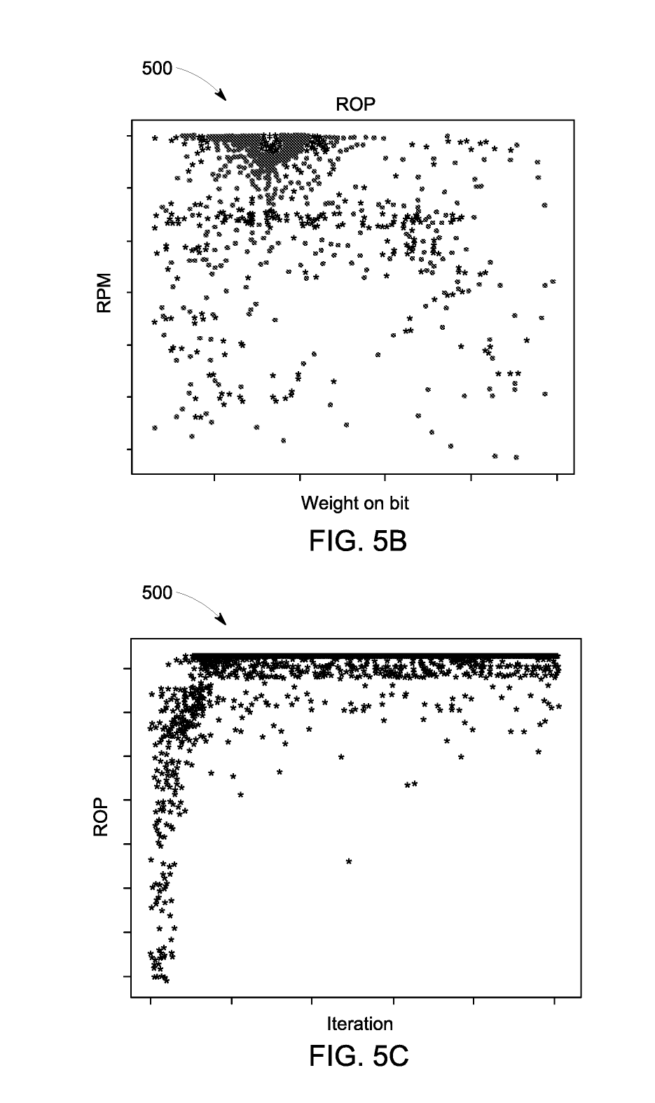

Returning to FIG. 1, at 106, the generated predictive model (e.g., predictive models used to generate FIGS. 5A-C) can be used to determine target operating parameters of the drill corresponding to a target rate of penetration in the first rock formation. The target rate of penetration can be determined by applying an optimization algorithm (e.g., global optimization algorithm) to the predictive model. The optimization algorithm can include, for example, genetic algorithms, evolutionary algorithms, simulated annealing, particle swarm optimization, gradient based optimization, and the like. The optimization algorithms can determine one or more values of the target rate of penetration (and the corresponding target operating parameters) based on one or more operating constraints of the drill (e.g., lateral and axial vibrations, stick-slip, errors in the predictive models, and the like). FIG. 5A illustrates target rate of penetration (e.g., calculated using optimization algorithm described above) values on a three dimensional plot of rate of penetration obtained from a predictive model. FIG. 5B illustrates a two dimensional representation of the plot in FIG. 5A. FIG. 5C illustrates the convergence of calculated ROP and the corresponding operating conditions for the various iterations of the optimization algorithm. FIGS. 5A and 5B illustrate the feasible operating conditions by an asterisk and the operating conditions that are not feasible in black dots. Several constraints, for example, axial/lateral vibrations, rpm fluctuations and the like are used to determine feasibility of operating conditions.

Returning to FIG. 1, at 108, the determined target operating parameters are provided. For example, the determined targeted operating parameters can be saved in a database and/or presented to an operator. In another implementation, the targeted operating parameters can be used in an automated system to determine desirable (e.g., optimal) operating parameters of a drill in real-time, and change the operating parameters of the drill based on this determination.

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Other embodiments are within the scope and spirit of the disclosed subject matter. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving sensor data characterizing one or more properties of a first formation undergoing drilling;
determining, based on the received sensor data and a plurality of clustered historical data, an identity of the first formation;
determining, based on one or more of the identity of the first formation and a target rate of penetration, a target operating parameter of a drill configured to penetrate the first formation, the target operating parameter configured to achieve the target rate of penetration of the drill through the first formation; and
varying the operation of the drill based on the target operating parameter.

2. The method of claim 1, further comprising generating clustered historical data, the generating comprising:
receiving historical sensor data indicative of detected properties of a plurality of formations including the first formation;
encoding the historical sensor data into encoded data;
clustering the encoded data into a plurality of clustered encoded data indicative of the plurality of formations; and
clustering the historical sensor data into a plurality of clustered historical data based on the plurality of clustered encoded data, the plurality of clustered historical data indicative of the plurality of formations.

3. The method of claim 2, wherein clustering the encoded data into the plurality of clustered encoded data includes applying an unsupervised clustering algorithm on the encoded data, the unsupervised clustering algorithm configured to:
identify a first formation property in the encoded data; and
cluster the encoded data based on the first formation property.

4. The method of claim 2, wherein determining the identity of the first formation includes:
identifying a first clustered historical data of the plurality of clustered historical data representative of the received sensor data; and
setting the identity of the first formation to a formation associated with the first clustered historical data.

5. The method of claim 4, further comprising generating a predictive model for the first formation based at least on the first clustered historical data, wherein the predictive model is configured to determine the target operating parameter based on the identity of the first formation and the target rate of penetration.

6. The method of claim 5, wherein generating the predictive model includes:
determining one or more coefficients of a characteristic equation, the characteristic equation configured to receive a value representative of the first formation and the target rate of penetration as an input and generate the target operating parameter as an output.

7. The method of claim 5, wherein the predictive model is one of a Bayesian hybrid model and a Gaussian process based model.

8. The method of claim 5, wherein the predictive model is generated by a global evolutionary algorithm.

9. A system comprising:
at least one data processor;
memory coupled to the at least one data processor, the memory storing instructions to cause the at least one data processor to perform operations comprising:
receiving sensor data characterizing one or more properties of a first formation undergoing drilling;
determining, based on the received sensor data and a plurality of clustered historical data, an identity of the first formation;
determining, based on one or more of the identity of the first formation and a target rate of penetration, a target operating parameter of a drill configured to penetrate the first formation, the target operating parameter configured to achieve the target rate of penetration of the drill through the first formation; and
varying the operation of the drill based on the target operating parameter.

10. The system of claim 9, wherein the operations further include generating clustered historical data, the generating comprising:
receiving historical sensor data indicative of detected properties of a plurality of formations including the first formation;
encoding the historical sensor data into encoded data;
clustering the encoded data into a plurality of clustered encoded data indicative of the plurality of formations; and
clustering the historical sensor data into a plurality of clustered historical data based on the plurality of clustered encoded data, the plurality of clustered historical data indicative of the plurality of formations.

11. The system of claim 10, wherein clustering the encoded data into the plurality of clustered encoded data includes applying an unsupervised clustering algorithm on the encoded data, the unsupervised clustering algorithm configured to:
identify a first formation property in the encoded data; and
cluster the encoded data based on the first formation property.

12. The system of claim 10, wherein determining the identity of the first formation includes:
identifying a first clustered historical data of the plurality of clustered historical data representative of the received sensor data; and
setting the identity of the first formation to a formation associated with the first clustered historical data.

13. The system of claim 12, wherein the operations further include generating a predictive model for the first formation based at least on the first clustered historical data, wherein the predictive model is configured to determine the target operating parameter based on the identity of the first formation and the target rate of penetration.

14. The system of claim 13, wherein generating the predictive model includes:
determining one or more coefficients of a characteristic equation, the characteristic equation configured to receive a value representative of the first formation and the target rate of penetration as an input and generate the target operating parameter as an output.

15. The system of claim 13, wherein the predictive model is one of a Bayesian hybrid model and a Gaussian process based model.

16. The system of claim 13, wherein the predictive model is generated by a global evolutionary algorithm.

17. A computer program product comprising a non-transitory machine-readable medium storing instructions that, when executed by at least one programmable processor that comprises at least one physical core and a plurality of logical cores, cause the at least one programmable processor to perform operations comprising:
receiving sensor data characterizing one or more properties of a first formation undergoing drilling;
determining, based on the received sensor data and a plurality of clustered historical data, an identity of the first formation;
determining, based on one or more of the identity of the first formation and a target rate of penetration, a target operating parameter of a drill configured to penetrate the first formation, the target operating parameter configured to achieve the target rate of penetration of the drill through the first formation; and
varying the operation of the drill based on the target operating parameter.

18. The computer program product of claim 17, wherein the operations further include generating clustered historical data, the generating comprising:
receiving historical sensor data indicative of detected properties of a plurality of formations including the first formation;
encoding the historical sensor data into encoded data;
clustering the encoded data into a plurality of clustered encoded data indicative of the plurality of formations; and
clustering the historical sensor data into a plurality of clustered historical data based on the plurality of clustered encoded data, the plurality of clustered historical data indicative of the plurality of formations.

19. The computer program product of claim 18, wherein clustering the encoded data into the plurality of clustered encoded data includes applying an unsupervised clustering algorithm on the encoded data, the unsupervised clustering algorithm configured to:
identify a first formation property in the encoded data; and
cluster the encoded data based on the first formation property.

20. The computer program product of claim 18, wherein determining the identity of the first formation includes:
identifying a first clustered historical data of the plurality of clustered historical data representative of the received sensor data; and
setting the identity of the first formation to a formation associated with the first clustered historical data.
